(19) United States
(12) Patent Application Publication
(10) Pub. No.: US 2026/0087951 A1
(43) Pub. Date: Mar. 26, 2026

(54) BRAND MARKETING SYSTEM AND METHOD FOR NATURALLY EXPRESSING CORPORATE BRAND LOGO IN VIDEO DISPLAYING MOVING OBJECT

(71) Applicant: Sidewalk Entertainment Inc., Seoul (KR)

(72) Inventors: Ki Bong KOOK, Goyang-si (KR); Kyung Heun KIM, Seoul (KR); Ju Won KO, Seoul (KR); Tae Hoon KIM, Incheon (KR)

(21) Appl. No.: 19/320,041

(22) Filed: Sep. 5, 2025

(30) Foreign Application Priority Data
Sep. 24, 2024 (KR) 10-2024-0129326
Nov. 19, 2024 (KR) 10-2024-0164825

(51) Int. Cl. G09F 19/00; G06Q 30/0251; G06Q 30/0272; G09F 19/14

(52) U.S. Cl. CPC G09F 19/002; G06Q 30/0252; G06Q 30/0272; G09F 19/14

(57) ABSTRACT

Disclosed are a brand marketing system and method for naturally expressing a corporate brand logo in a video displaying a moving object. At least one first user terminal configured to generate and transmit video data obtained by capturing a moving object, and a video provision device configured to insert a predetermined corporate brand logo into a set logo display portion in the video data according to text data corresponding to an advertiser requirement are included.

### CROSS REFERENCE TO RELATED APPLICATION

The present application claims priority to Korean Patent Application Nos. 10-2024-0129326 and 10-2024-0164825, filed Sep. 24, 2024 and Nov. 19, 2024 respectively, the entire contents of which are incorporated herein for all purposes by this reference.

### BACKGROUND

### Field of the Invention

The present invention relates to a brand marketing system and method, and more particularly to a brand marketing system and method for promoting a corporate brand by naturally exposing a logo for corporate promotion in a video displaying a moving object such as a dance battle.

### Description of the Related Art

With the rapid growth of the cultural and artistic market, diverse cultural and artistic performances, including musical performances, dance, and instrumental music, have gained popularity. Recently, dance battles have gained significant popularity due to the frequent appearance of dance battles where dancers take turns competing in dance skills across various media platforms and such dance battles are popular worldwide.

During dance battles, advertising for sponsors or related companies is necessary, which has been performed by inserting corporate logos or banners into a portion of a screen. However, this method has limited advertising effectiveness, and a logo or a banner may block part of the screen, obscuring dance battle competitors from viewers, so that the viewers may have aversion to the logo or the banner. Furthermore, some time may be devoted to corporate advertising, which may disrupt a flow of a dance battle.

Therefore, there is need for a method of increasing awareness and familiarity of a corporate brand by naturally exposing a logo or a banner for corporate promotion while allowing viewers watching a dance battle video to focus on a dance battle.

### SUMMARY

Therefore, the present invention has been made in view of the above problems, and it is an object of the present invention to provide a brand marketing system and method for promoting a corporate brand by naturally exposing a logo for corporate promotion in a video displaying a moving object such as a dance battle.

In accordance with an aspect of the present invention, the above and other objects can be accomplished by the provision of a brand marketing system including at least one first user terminal configured to generate and transmit video data obtained by capturing a moving object, and a video provision device configured to insert a predetermined corporate brand logo into a set logo display portion in the video data according to text data corresponding to an advertiser requirement.

The video provision device may analyze the video data received from the at least one first user terminal, and when movement of the moving object matches dance battle start movement included in the advertiser requirement, the video provision device may transmit data for starting a dance battle game to the at least one first user terminal, and collect dance battle video data captured by the at least one first user terminal.

The brand marketing system may further include at least one second user terminal configured to generate eye-tracking data by performing gaze tracking on a user while displaying the dance battle video data provided from the video provision device and transmit the eye-tracking data, wherein the video provision device may collect the eye-tracking data from the at least one second user terminal, extract a preferred gaze portion where the gaze of the user lingers for a preset time or more as the logo display portion, and then insert the corporate brand logo according to the advertiser requirement.

The video provision device may include a communication unit configured to receive the dance battle video data captured by the at least one first user terminal, and to receive the eye-tracking data generated by the at least one second user terminal, a preprocessing unit configured to convert text data corresponding to the advertiser requirement into tokenized data, a storage unit configured to store the tokenized data, and the dance battle video data and the eye-tracking data collected by the communication unit, and a processor configured to analyze the dance battle video data to identify a dance genre, then analyze the eye-tracking data to extract, as the logo display portion, a body part of a dancer where gaze of a user lingers for a preset time or more when the dance genre is determined to be similar to a dance genre included in the advertiser requirement stored in a form of the tokenized data in the storage unit, and perform processing so that the corporate brand logo is dynamically displayed in the logo display portion according to movement of the dancer.

The video provision device may provide, as a recommended video, dance battle video data in order of a number of times that the corporate brand logo is inserted.

In accordance with another aspect of the present invention, there is provided a brand marketing method of a video provision device configured to communicate with at least one first user terminal and at least one second user terminal, the brand marketing method including inputting text data corresponding to an advertiser requirement to the video provision device to convert the text data into tokenized data, receiving video data obtained by capturing a moving object from the at least one first user terminal, and inserting, by the video provision device, a predetermined corporate brand logo into a set logo display portion in the video data according to the advertiser requirement in a form of the tokenized data.

The brand marketing method may further include analyzing the video data transmitted from the at least one first user terminal, and transmitting data for starting a dance battle game to the at least one first user terminal from the video provision device when movement of the moving object matches dance battle start movement included in the advertiser requirement, and collecting, by the video provision device, dance battle video data captured by the at least one first user terminal.

The brand marketing method may further include generating eye-tracking data by performing gaze tracking on a user while displaying the dance battle video data on the at last one second user terminal receiving the dance battle video data provided from the video provision device and transmitting the eye-tracking data to the video provision device, and collecting, by the video provision device, the eye-tracking data transmitted from the at least one second user terminal.

The brand marketing method may further include analyzing the dance battle video data to identify a dance genre, and then determining whether the dance genre is similar to a dance genre included in the advertiser requirement, analyzing the eye-tracking data to extract, as the logo display portion, a body part of a dancer where the gaze of the user lingers for a preset time or more, and performing processing so that the corporate brand logo is dynamically displayed in the logo display portion according to movement of the dancer.

The brand marketing method may further include providing, as a recommended video, dance battle video data in order of a number of times that the corporate brand logo is inserted.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a schematic configuration of a brand marketing system according to all embodiments of the present invention;

FIG. 2 is a block diagram illustrating a schematic configuration of a video provision device included in the brand marketing system according to all embodiments of the present invention;

FIG. 3 is a diagram for describing a method of inserting a brand logo by the brand marketing system according to an embodiment of the present invention;

FIG. 4 is a diagram for describing a method of inserting a brand logo by the brand marketing system according to another embodiment of the present invention; and

FIG. 5 is a flowchart for describing another brand marketing method according to all embodiments of the present invention.

### DETAILED DESCRIPTION OF EXEMPLARY EMBODIMENTS

Hereinafter, a detailed description will be given of a brand marketing system and method (hereinafter, a brand marketing system and a brand marketing method) for naturally expressing a corporate brand logo in a video displaying a moving object according to a preferred embodiment of the present invention with reference to the accompanying drawings.

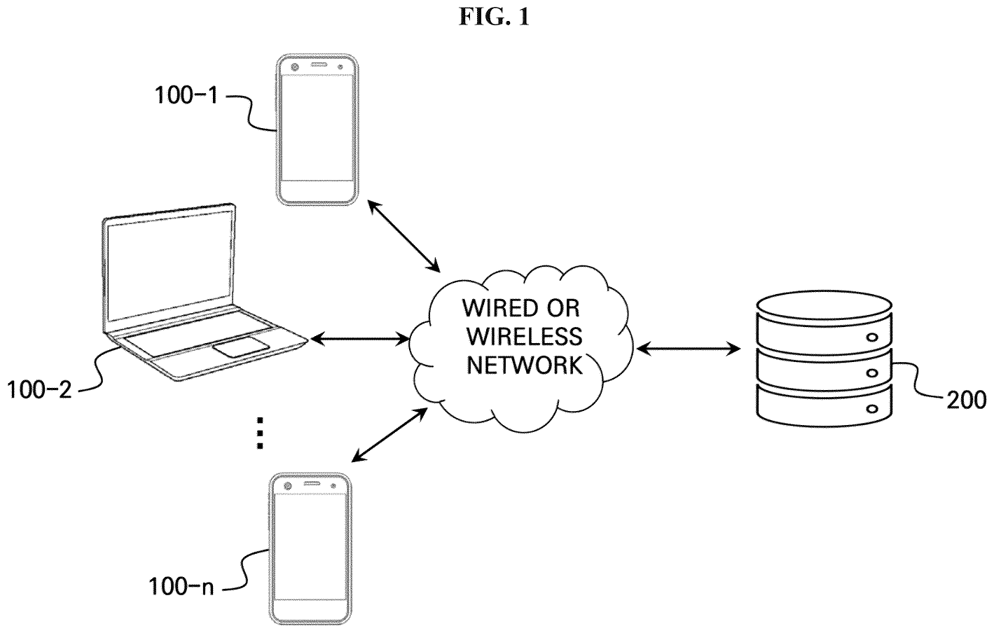

FIG. 1 is a diagram illustrating a schematic configuration of the brand marketing system according to all embodiments of the present invention.

Referring to FIG. 1, the brand marketing system of the present invention includes first to Nth user terminals 100-1, 100-2, . . . , 100-n and a video provision device 200 connected via a wired or wireless network. The wired or wireless network is a generic term for a communication network that supports various communication standards or protocols for pairing or data transmission/reception between the video provision device 200 and the first to Nth user terminals 100-1, 100-2, . . . , 100-n. Such a wired or wireless network includes all communication networks currently or to be supported in the future by standards, and may support one or more communication protocols therefor.

The first to Nth user terminals 100-1, 100-2, . . . , 100-n of the present invention may communicate with the video provision device 200 via wired or wireless communication to transmit, receive, and display predetermined data. The first to Nth user terminals 100-1, 100-2, . . . , 100-n may be implemented as mobile terminals such as mobile phones, smartphones, tablets, and ultrabooks. However, the present invention is not limited thereto, and may include stationary devices such as desktop computers, microprocessors, mainframe computers, digital processors, and device controllers.

The first user terminal 100-1 generates video data obtained by capturing a moving object and transmits the video data to the video provision device 200. In the embodiment of the present invention, a case of capturing a dance battle will be described as an example, but the present invention is not limited thereto. The first user terminal 100-1 is a terminal device belonging to a user who wishes to participate in a dance battle game, and the terminal device generates dance battle video data obtained by capturing a dance battle and transmits the dance battle video data to the video provision device 200.

The second user terminal 100-2 receives and displays the dance battle video data provided by the video provision device 200. That is, the second user terminal 100-2 is a terminal device belonging to a user who wishes to watch the dance battle game, and the terminal device generates eye-tracking data by performing gaze tracking on the user while the dance battle video is displayed, and transmits the eye-tracking data to the video provision device 200.

In the present invention, the video provision device 200 refers to a server, but is not limited to the server. The video provision device may also refer to a fixed device such as a desktop computer or a mobile device such as a smartphone, a tablet, or a notebook, and may be used to encompass all devices unless specified otherwise. Here, the server refers to a device or system that transmits data to or receives data from various types of user terminals, i.e., clients.

The video provision device 200 collects dance battle video data captured from at least one first user terminal 100-1 and provides the dance battle video data to at least one second user terminal 100-2. The video provision device 200 inserts a predetermined corporate brand logo into a set logo display portion of the dance battle video data according to a requirement of an advertiser and provides the dance battle video data.

In this instance, the advertiser requirement may be input as text data to the video provision device 200 or transmitted from the third user terminal (not illustrated), and the advertiser requirement may include a corporate brand name or a product name to be inserted into the dance battle video data, a dance genre for which a brand logo is desired to be inserted, and dance battle start movement for starting the dance battle game.

The video provision device 200 analyzes the video data received from the first user terminal 100-1. When movement of a moving object matches the dance battle start movement included in the advertiser requirement, the video provision device 200 transmits data for starting the dance battle game to the first user terminal 100-1 and collects the dance battle video data captured through the first user terminal 100-1.

In addition, the video provision device 200 collects eye-tracking data from the second user terminal 100-2 displaying the dance battle video data, extracts a preferred gaze portion where the gaze of the user lingers for a preset time or more as the logo display portion, and then inserts the corporate brand logo according to the advertiser requirement. Further, the video provision device 200 provides the dance battle video data as a recommended video in order of the number of times that the corporate brand logo is inserted.

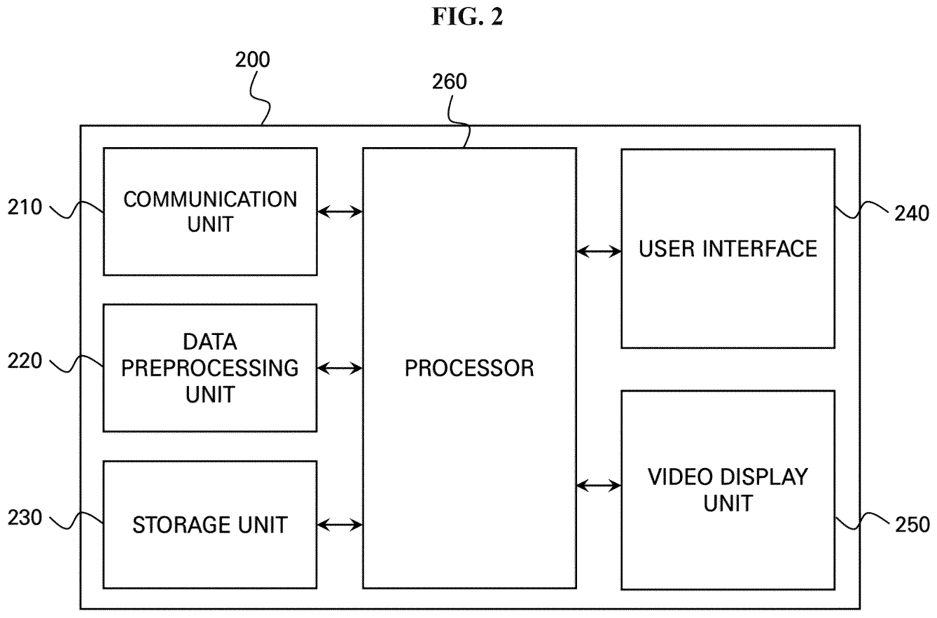

FIG. 2 is a block diagram illustrating a schematic configuration of the video provision device included in the brand marketing system according to all embodiments of the present invention.

Referring to FIG. 2, the video provision device 200 includes a communication unit 210, a data preprocessing unit 220, a storage unit 230, a user interface 240, a video display unit 250, and a processor 260. Each component may be integrated, added, or omitted depending on the specifications of the video provision device 200 which is actually implemented. That is, as needed, two or more components may be combined into one component, or one component may be subdivided into two or more components. Furthermore, a function performed by each block is intended to illustrate embodiments of the present disclosure, and a specific operation or device thereof does not limit the scope of the present invention.

The communication unit 210 may include one or more modules that enable wired or wireless communication between the video provision device 200 and the wired or wireless network, between the video provision device 200 and another device, or between the video provision device 200 and an external server. Furthermore, the communication unit 210 may include one or more modules that connect the video provision device 200 to one or more networks. Furthermore, the communication unit 210 refers to a module for accessing the wired or wireless network, and may be built into or externally mounted on the video provision device 200 and configured to transmit and receive wired or wireless signals.

In the present invention, the communication unit 210 receives dance battle video data captured by the first user terminal 100-1 and eye-tracking data generated by the second user terminal 100-2. Furthermore, the communication unit 210 may receive text data corresponding to the advertiser requirement from the third user terminal (not illustrated). In other words, the third user terminal is a terminal belonging to the advertiser, the advertiser inputs the advertiser requirement as text to the third user terminal, and text data corresponding to the advertiser requirement is transmitted to the video provision device 200.

The data preprocessing unit 220 converts the text data corresponding to the advertiser requirement into tokenized data. In other words, the text data corresponding to the advertiser requirement is converted into tokenized data through processes such as morphological analysis, part-of-speech tagging, and noun extraction.

The storage unit 230 may store data supporting various functions of the video provision device 200. That is, the storage unit 230 may store a plurality of application programs executed on the video provision device 200, and data, instructions, and at least one program instruction for an operation of the video provision device 200. At least some of these application programs may be present on the video provision device 200 from the time of shipment for the basic functions of the video provision device 200, or may be downloaded from an external server via wireless communication. Furthermore, the storage unit 230 stores the advertiser requirement in the form of the tokenized data, and the dance battle video data and the eye-tracking data collected via the communication unit 210.

The user interface 240 is implemented as a key or touch-type screen or mouse, and receives a user instruction. In the present invention, text corresponding to the advertiser requirement may be input through the user interface 240.

The video display unit 250 displays information or video data processed by the video provision device 200. For example, the video display unit 250 displays execution screen information of an application program executed on the video provision device 200 or information on a user interface (UI) or a graphical user interface (GUI) according to the execution screen information. In the present invention, the video display unit 250 displays a video when the dance battle video data received through the communication unit 210 or stored in the storage unit 230 is played. The video display unit 250 may be implemented in combination with a touch-type user interface.

The processor 260 may control the overall operation of the video provision device 200, and may process signals, data, information, etc. input or output through components of the video provision device 200 or execute an application program stored in the storage unit 230 to provide or process appropriate information or functions. In addition, the processor 260 may control at least some of the components of the video provision device 200 to execute the application program stored in the storage unit 230. Furthermore, the processor 260 may operate at least two or more of the components included in the video provision device 200 in combination to execute the application program.

In the present invention, the processor 260 analyzes dance battle video data to identify a dance genre and then determines whether the dance genre is similar to a dance genre included in the advertiser requirement stored in the storage unit 230 as tokenized data. When the dance genre is determined to be similar, the processor 260 analyzes the eye-tracking data to extract a body part of a dancer on which the gaze of the user lingers for a preset time or more as the logo display portion. Then, processing is performed so that the corporate brand logo is dynamically displayed in the logo display area according to movement of the dancer.

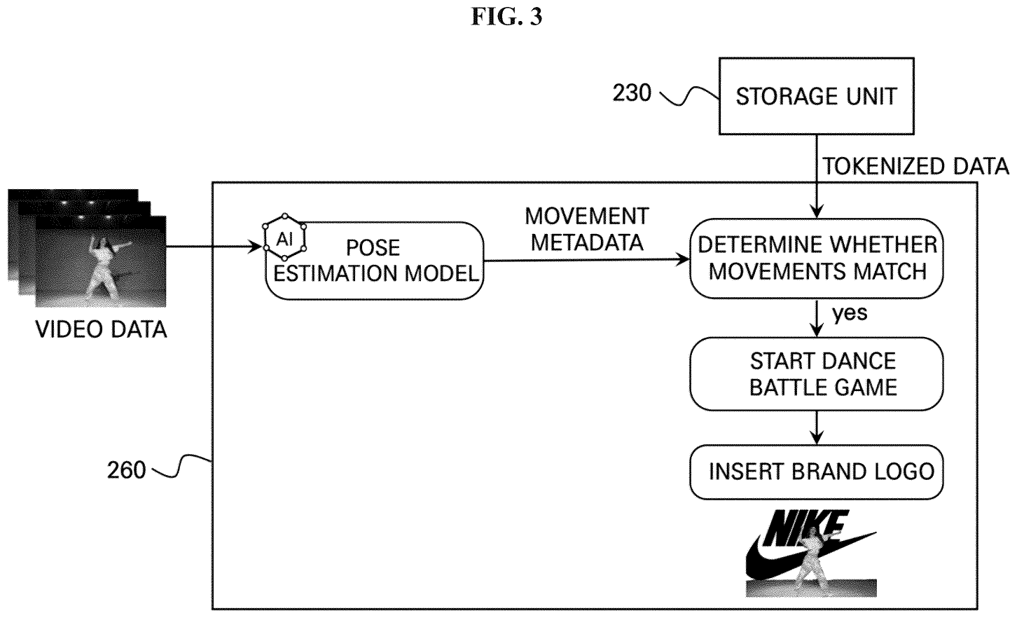

FIG. 3 is a diagram for describing a method of inserting a brand logo by the brand marketing system according to an embodiment of the present invention.

In the embodiment of FIG. 3, a case where text data “When the dancer performs a specific movement, start the dance battle game and add the Nike logo to the background.” is input as the advertiser requirement is given as an example.

The processor 260 inputs video data transmitted in real time from the first user terminal 100-1 to an AI-based pose estimation model to extract movement metadata. Then, the processor compares the dance battle start movement stored as tokenized data in the storage unit 230 with the movement metadata. When the movements are determined to match, data for starting the dance battle game is transmitted to the first user terminal 100-1, and the dance battle video data is stored in the storage unit 230. Further, as illustrated in FIG. 3, the brand logo is inserted into the dance battle video data so that the Nike logo appears in a background of the dancer, and the data is transmitted in real time to the second user terminal 100-2.

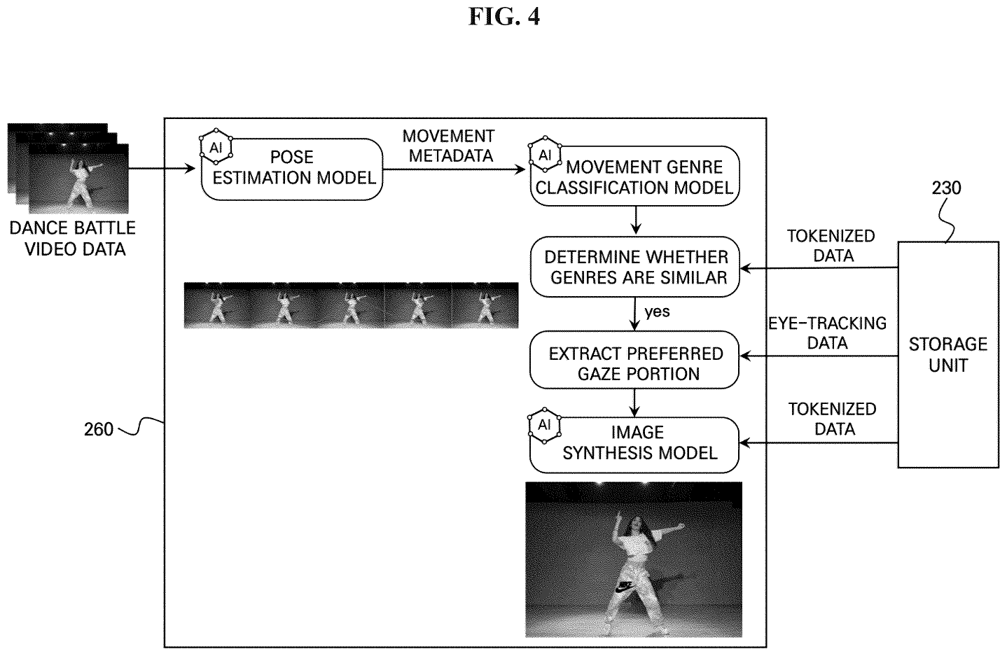

FIG. 4 is a diagram for describing a method of inserting the brand logo by the brand marketing system according to another embodiment of the present invention.

In the embodiment of FIG. 4, a case where text data “Please place the Nike logo on the most-viewed body part in the hip-hop genre dance battle.” is input as the advertiser requirement is given as an example.

The processor 260 inputs the dance battle video data stored in the storage unit 230 to the AI-based pose estimation model to extract movement metadata. Then, the processor compares a dance genre classified by an AI-based movement genre classification model with a “hip-hop genre”, which is a dance genre included in the advertiser requirement stored in the storage unit 230 as tokenized data, to determine whether the genres are similar. When the genres are determined to be similar, the processor 260 analyzes the eye-tracking data stored in the storage unit 230 to extract a body part of the dancer on which the gaze of the user lingers for a preset time or more as the logo display portion. Further, the corporate brand logo, which is included in the advertiser requirement stored in the storage unit 230 as tokenized data, is synthesized with the logo display portion. In this instance, the processor 260 performs processing so that the brand logo is dynamically displayed in the logo display portion according to the movement of the dance using an AI-based image synthesis model.

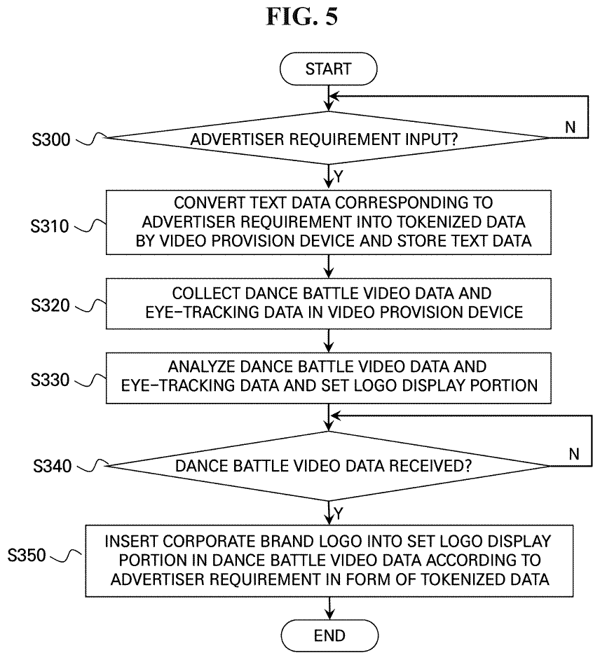

FIG. 5 is a flowchart for describing another brand marketing method according to all embodiments of the present invention.

According to FIG. 5, first, in response to the advertiser requirement being input to the video provision device 200 (S300-Y), text data corresponding to the advertiser requirement is converted into tokenized data by the video provision device 200 and stored (S310).

The dance battle video data and the eye-tracking data are collected in the video provision device 200 (S320). That is, the video provision device 200 analyzes the video data transmitted from the first user terminal 100-1, and when the movement of the moving object matches the dance battle start movement included in the advertiser requirement, the video provision device 200 transmits the data for starting the dance battle game to the first user terminal 100-1, and collects the dance battle video data captured by the first user terminal 100-1. Further, the eye-tracking data is generated by performing gaze tracking on the user while displaying the dance battle video data on the second user terminal 100-2, which has received the dance battle video data provided from the video provision device 200, and transmitted to the video provision device 200, and the video provision device 200 collects the eye-tracking data from the second user terminal 100-2.

The video provision device 200 analyzes the dance battle video data and the eye-tracking data to set the logo display portion (S330). More specifically, the video provision device 200 analyzes the dance battle video data to identify the dance genre, and then determines whether the dance genre of the dance battle is similar to the dance genre included in the advertiser requirement. When the dance genre of the dance battle is determined to be similar to the dance genre included in the advertiser requirement, the eye-tracking data is analyzed. As a result of analyzing the eye-tracking data, the preferred gaze portion where the gaze of the user lingers for a preset time or more is extracted as the logo display portion. In this instance, a body part of the dancer on which the gaze of the user lingers for a preset time or more may be extracted as the logo display portion.

When the dance battle video data captured by the first user terminal 100-1 is received by the video provision device 200 (S340-Y), a predetermined corporate brand logo is inserted into the set logo display portion in the video data according to the advertiser requirement in the form of tokenized data (S350). In this instance, when the logo display portion is a body part of the dancer, processing is performed so that the corporate brand logo is dynamically displayed in the logo display portion according to the movement of the dancer.

The video provision device 200 provides, as a recommended video, dance battle video data in order of the number of times that the corporate brand logo is inserted among pieces of the dance battle video data with the corporate brand logo inserted.

Through the above process, the corporate brand logo may be naturally displayed in accordance with movement and performance of the dancer.

According to the brand marketing system and method of the present invention, it is possible to minimize advertising fatigue by naturally displaying the corporate brand logo in accordance with movement and performance of the dancer, and to increase the exposure frequency and attention of advertisement by displaying the brand logo in a part most preferred by the viewers using the eye-tracking data.

In addition, it is possible to maximize advertising effectiveness by causing the viewers to be able to pay attention to a scene where the brand logo is inserted in a fast and dynamic video such as a dance battle, and to satisfy needs of the advertiser by appropriately connecting a target and content desired by the advertiser.

What is claimed is:

1. A brand marketing system comprising:
at least one first user terminal configured to generate and transmit video data obtained by capturing a moving object; and
a video provision device configured to insert a predetermined corporate brand logo into a set logo display portion in the video data according to text data corresponding to an advertiser requirement.

2. The brand marketing system according to claim 1, wherein the video provision device analyzes the video data received from the at least one first user terminal, and when movement of the moving object matches dance battle start movement included in the advertiser requirement, the video provision device transmits data for starting a dance battle game to the at least one first user terminal, and collects dance battle video data captured by the at least one first user terminal.

3. The brand marketing system according to claim 2, further comprising at least one second user terminal configured to generate eye-tracking data by performing gaze tracking on a user while displaying the dance battle video data provided from the video provision device and transmit the eye-tracking data,
wherein the video provision device collects the eye-tracking data from the at least one second user terminal, extracts a preferred gaze portion where the gaze of the user lingers for a preset time or more as the logo display portion, and then inserts the corporate brand logo according to the advertiser requirement.

4. The brand marketing system according to claim 3, wherein the video provision device comprises:
a communication unit configured to receive the dance battle video data captured by the at least one first user terminal, and to receive the eye-tracking data generated by the at least one second user terminal;
a preprocessing unit configured to convert text data corresponding to the advertiser requirement into tokenized data;
a storage unit configured to store the tokenized data, and the dance battle video data and the eye-tracking data collected by the communication unit; and
a processor configured to analyze the dance battle video data to identify a dance genre, then analyze the eye-tracking data to extract, as the logo display portion, a body part of a dancer where gaze of a user lingers for a preset time or more when the dance genre is determined to be similar to a dance genre included in the advertiser requirement stored in a form of the tokenized data in the storage unit, and perform processing so that the corporate brand logo is dynamically displayed in the logo display portion according to movement of the dancer.

5. The brand marketing system according to claim 3, wherein the video provision device provides, as a recommended video, dance battle video data in order of a number of times that the corporate brand logo is inserted.

6. A brand marketing method of a video provision device configured to communicate with at least one first user terminal and at least one second user terminal, the brand marketing method comprising:
inputting text data corresponding to an advertiser requirement to the video provision device to convert the text data into tokenized data;
receiving video data obtained by capturing a moving object from the at least one first user terminal; and
inserting, by the video provision device, a predetermined corporate brand logo into a set logo display portion in the video data according to the advertiser requirement in a form of the tokenized data.

7. The brand marketing method according to claim 6, further comprising:
analyzing the video data transmitted from the at least one first user terminal, and transmitting data for starting a dance battle game to the at least one first user terminal from the video provision device when movement of the moving object matches dance battle start movement included in the advertiser requirement; and
collecting, by the video provision device, dance battle video data captured by the at least one first user terminal.

8. The brand marketing method according to claim 7, further comprising:
generating eye-tracking data by performing gaze tracking on a user while displaying the dance battle video data on the at last one second user terminal receiving the dance battle video data provided from the video provision device and transmitting the eye-tracking data to the video provision device; and
collecting, by the video provision device, the eye-tracking data transmitted from the at least one second user terminal.

9. The brand marketing method according to claim 8, further comprising:
analyzing the dance battle video data to identify a dance genre, and then determining whether the dance genre is similar to a dance genre included in the advertiser requirement;
analyzing the eye-tracking data to extract, as the logo display portion, a body part of a dancer where the gaze of the user lingers for a preset time or more; and
performing processing so that the corporate brand logo is dynamically displayed in the logo display portion according to movement of the dancer.

10. The brand marketing method according to claim 8, further comprising providing, as a recommended video, dance battle video data in order of a number of times that the corporate brand logo is inserted.
